(19) United States
(12) Patent Application Publication
(10) Pub. No.: US 2014/0011057 A1
(43) Pub. Date: Jan. 9, 2014

(54) HYBRID ELECTROCHEMICAL ENERGY STORE

(71) Applicant: Li-Tec Battery GmbH, Kamenz (DE)

(72) Inventor: Tim SCHAEFER, Harztor (DE)

(21) Appl. No.: 13/934,504

(22) Filed: Jul. 3, 2013

Related U.S. Application Data
(60) Provisional application No. 61/668,095, filed on Jul. 5, 2012.

(30) Foreign Application Priority Data
Jul. 5, 2012 (DE) 10 2012 013 413.4

(51) Int. Cl. H01M 10/42

(52) U.S. Cl. CPC H01M 10/4207
USPC 429/50; 429/158

(57) ABSTRACT

In the case of an arrangement of electrochemical energy stores with at least one first rechargeable electrochemical energy store E1 and at least one second rechargeable electrochemical energy store E1, wherein the first and the second energy stores are connected to one another in such a manner that both energy stores can exchange energy with one another and with at least one external energy source ES and with at least one external energy drain ED via energy currents S1, S2, S12, a device SE for controlling at least one of the energy currents in or out of the first and the second energy store is provided in such a manner that damage or overloading of the first energy store can be prevented or reduced, whilst accepting damage or overloading of the second energy store.

The present invention relates to an electrochemical energy store, particularly an electrochemical energy store operating on the basis of lithium ions.

For the commercial use of electrochemical energy stores, in addition to other factors, their construction, which is as simple and cost-effective as possible, and the greatest possible safety when handling such energy stores are decisive. Safety is principally endangered in connection with electrochemical energy stores if the galvanic cells contained therein overheat or such an overheating is imminent due to strong heat generation. Strong heat generation can for example be the consequence of internal or external short circuits, reactions in the case of overcharging, in the case of overloading, the influence of external heat sources, charging with high current, charging with high load factor, starting charging at an already high temperature and poor cooling.

WO 03/088373 A2 describes a hybrid battery configuration which supplies a consumer with changing current requirement, which lies between short-term phases with high currents and longer-term phases with medium or low currents. This battery configuration comprises a first energy store with the capacity for high power output, a second energy store with high energy store capacity, a current monitoring device, a microprocessor control and at least one switch. The switch is controlled by the microprocessor in such a manner that at least the first or the second energy store is connected in series to the consumer.

WO 99/52163 A1 describes a battery with a built-in control which should lengthen the service life of the battery in that the cell voltage is converted into an output voltage which is higher than the operational voltage of an electronic device, or into an output voltage which is lower than the nominal voltage of the electrochemical cells of the battery, or in that the electrochemical cell is protected from current spikes.

WO 2004/06815 A2 describes a hybrid battery for implantable medical devices. The hybrid battery consists of a primary cell with comparatively high energy density and of a (rechargeable) secondary cell with comparatively low internal resistance. Both cells are connected in series via a control circuit, which is set up to charge the secondary cell and in the process to limit the charging/discharging cycles of the secondary cell in such a manner that the power output thereof for highly energetic applications is optimised by means of medical devices.

WO 03/088375 A2 describes a hybrid battery system consisting of a high-power battery with low impedance, which is connected in parallel to a high-energy battery. In the fully charged state, both batteries essentially have the same rest terminal voltage. The ampere hour capacity of the high-energy battery up to a predetermined limit voltage is at least twenty times the ampere hour capacity of the ampere hour capacity of the high-power battery up to the same limit voltage.

An object to be achieved by means of the present invention can be seen in improving known electrochemical energy stores if possible. This object is achieved by means of a product according to one of the independent product claims or by means of a method according to one of the independent method claims. The subclaims should protect advantageous developments of the present invention.

The invention provides an arrangement of electrochemical energy stores with at least one first rechargeable electrochemical energy store and at least one second rechargeable electrochemical energy store, wherein the first and the second energy stores are connected to one another in such a manner that both energy stores can exchange energy with one another and with at least one external energy source and/or with at least one external energy drain via energy currents. One device for controlling at least one of the energy currents in or out of the first and the second energy store controls the energy currents in such a manner that damage or overloading of the first energy store can be prevented or reduced, whilst accepting damage or overloading of the second energy store.

In the sense of the invention, an electrochemical energy store should be understood to mean a device which can store energy in chemical form and output the same in electrical form to a consumer, i.e. to an energy drain. A rechargeable electrochemical energy store can furthermore receive energy in electrical form from one energy store and store the same in chemical form. Electrochemical energy stores are individual galvanic cells or arrangements of a plurality of galvanic cells. The latter are also termed batteries, although this term is also often used for individual galvanic cells. In the case of the galvanic cells, a difference is made between primary cells and secondary cells. Galvanic cells which cannot be recharged following discharging are termed galvanic cells. Secondary cells, also termed accumulators or simply “accus” are galvanic cells which can be recharged following discharging.

In an accumulator, electrical energy is converted into chemical energy during charging. If a consumer is connected, then the chemical energy is converted back into chemical energy again. The typical electrical nominal voltage for an electrochemical cell, the efficiency and the energy density depend on the type of materials used. For applications as drive battery (traction battery) for vehicles, the energy density is important. The higher this is, the more energy can be stored in an accu per unit mass or per unit volume. When charging and discharging accumulators, heat is released by means of the internal resistance of the cells, as a result of which a portion of the energy expended for charging is lost.

The ratio of the receivable to the energy to be expended during charging is termed the charging efficiency. Generally, the charging efficiency drops both during fast charging with very high currents and due to rapid discharging, as the losses in terms of internal resistance increase. The optimal usage window in this case is vastly different, depending on cell chemistry. Accumulators of identical or different cell chemistry can be combined with one another either in series connection for increasing the usable electric voltage or else in parallel connection for increasing the usable capacity of a battery and the loadability thereof by high currents. By a suitable combination of series and parallel connections of accumulators, the requirements of a wide range of applications can be fulfilled.

Important examples for primary cells are the alkali manganese battery, the lithium battery, the lithium iron sulphide battery, the lithium manganese dioxide battery, the lithium thionyl chloride battery, the lithium sulphur dioxide battery, the lithium carbon monofluoride battery, the nickel oxyhydroxide battery, the mercury zinc battery, the silver oxide zinc battery, the zinc manganese dioxide cell, the zinc chloride battery and the zinc air battery. Important examples for secondary cells are the lead accumulator, the sodium sulphur accumulator, the nickel cadmium accumulator, the nickel iron accumulator, the nickel lithium accumulator, the nickel metal hydride accumulator, the nickel hydrogen accumulator, the nickel zinc accumulator, the lithium iron phosphate accumulator, the lithium ion accumulator, the lithium manganese accumulator, the lithium polymer accumulator, the lithium sulphur accumulator, the silver zinc accumulator, the vanadium redox accumulator, the zinc bromine accumulator, the zinc air accumulator, the zebra battery, the cellulose polypyrrole cell and the tin lithium accumulator.

A lead accumulator (also termed a lead acid accu or lead acid battery) is a realisation of the accumulator, in which in the charged state the electrodes consist of lead and lead dioxide and the electrolyte consists of dilute sulphuric acid. Lead accumulators stand out due to the short-time withdrawability of high current intensities. This property is for example advantageous for vehicle and starter batteries.

The term lithium ion battery (also lithium ion accu, Li ion accu, Li ion secondary battery, lithium accumulator or succinctly Li ion) is a generic term for an accumulator based on lithium. Li ion accus preferably supply portable devices with high energy requirement, for which conventional nickel cadmium or nickel metal hydride accus would be too heavy or too large, for example mobile telephones, digital cameras, camcorders, notebooks, handheld consoles or torches. They are used in the case of electromobility as energy source for pedelecs, electric and hybrid vehicles. Li ion accus stand out due to a high energy density. They are thermally stable and are not subject to a memory effect. Depending on the structure or the electrode materials used, Li ion accus are further subdivided into lithium polymer accumulators, lithium cobalt dioxide accumulators, lithium titanate accumulators, lithium air accumulators, lithium manganese accumulators, lithium iron phosphate accumulators and tin sulphur lithium ion accumulators.

The service life of a lithium ion accu is usually specified as a cycle life. The cycle life is dependent on the type and quality of the accu as well as on three external factors: the temperature, the (dis)charge hub and the charging rate (C rate). At high temperatures, the cycle life is reduced drastically, for which reason the accu should be cooled if possible. By means of proper charging and discharging with not too large a (dis)charge hub and not too large a (dis)charge rate, the durability is improved considerably, as high loads arise for the electrodes in the case of the completely discharged and completely charged accu.

The energy density of a lithium ion accu is significantly larger than the energy density of a nickel cadmium accumulator for example and is approximately 95-190 Wh/kg or 250-500 Wh/l, depending on the materials used. Applications which require a particularly long service life, for example use in electric cars, charging and discharging the lithium ion accu preferably only partially (e.g. from 30 to 80% instead of from 0 to 100%), which increases the number of possible charging and discharging cycles disproportionately, but correspondingly decreases the usable energy density.

The end of charge voltage of a lithium ion accu is typically 4.0 V-4.2 V. As Li ion accus do not have a memory effect, they are preferably initially charged with a constant current which preferably lies between 0.6 and 1 C. The abbreviation C here represents the relative charging current (measured in A/Ah) with regards to the capacity and must not be confused with the unit Coulomb (i.e. As). A charging current of 0.5 C for example means that an accu with a capacity of 1 Ah is charged with 0.5 A. If the accu reaches a cell voltage of 4.2 V, this voltage is preferably maintained until the charging current virtually disappears. The charging process is preferably ended when a charging current of 3% of the initial current is reached or as soon as the charging current no longer falls. Although fast charging electronics are available, which can be charged with up to 2 C or faster, the shortening of the charging time is achieved at the cost of the loss of a high capacity and service life of the accu. If the cell voltage lies below the deep discharge threshold, the charging electronics charge until the minimum voltage is reached, preferably initially only with a low current intensity.

The voltage of a typical Li ion accu barely falls during discharging. Only shortly before complete discharge does the cell voltage typically drop sharply. A typical end discharge voltage is 2.5 V. It should not drop below this, as otherwise the cell can be destroyed by irreversible chemical processes. An Li ion accu should preferably never be discharged from full charge to deep discharge. Preferably, a discharge depth of 70% should not be exceeded, wherein the accu still retains 30% residual capacity, before it is recharged. It has in the meantime become conventional to specify the cycle life as a function of the depth of discharge (DOD).

In the sense of the present invention, an energy current between two energy stores or between one energy store and an energy drain or an energy source should be understood to mean an exchange or energy between the involved partners of a charging/discharging process (i.e. energy store, energy source, energy drain). The energy current has—analogously to the electric current which has the physical dimension of an electric charge per unit time—the physical dimension of energy per unit time and is preferably measured in watts/second [W/s]. Depending on the sign of the energy current, the energy flows in one of two possible directions between the involved partners, that is to say one of the two partners is charged or discharged by means of the (i.e. to the detriment of or for the benefit of the) other partner. As an energy exchange via the energy currents in the sense of the present invention between the partners which come into consideration here is always an exchange of electrical energy, electric currents also always arise in connection with the energy currents in the sense of the present invention.

In spite of this connection, which is always present, between electric currents and energy currents in the processes relevant here for energy transfer, a conceptual distinction is made in the context of this description between energy currents and electric currents, because the size of the an energy current at a given electric current intensity can also depend on a voltage related to this current. A control of energy currents is therefore not to be equated in each case to a standalone control of the electric currents arising here, rather a control of the voltages arising here can also be included. Due to the fundamentally unavoidable energy losses, the Kirchhoff rules known from electrical engineering only apply for the energy currents in an approximation in which these energy losses can be ignored. By contrast, for the electric currents and voltages connected with these energy currents, the Kirchhoff rules apply under the conditions known from electrical engineering.

In the sense of the present invention, damage or an overloading of an electrochemical energy store should be understood to mean any process which disadvantageously influences a characteristic variable of this electrochemical energy store. Important examples of such characteristic variables are inter alia, the still available capacity, the remaining service life, preferably measured in still available storage cycles (cycle life), the energy efficiency, the efficiency (also termed Coulomb efficiency), the power density and the energy density. Damage in this sense is for the most part the consequence of overloading, particularly due to currents which are too high during the charging process (supply of energy to the energy store) or during the discharge process (removal of energy from the energy store), by means of the exceeding of limit values for the voltage or the temperature during the charging process or during the discharge process.

In the sense of the present invention, a device for controlling the energy currents should be understood to mean a device which controls the energy currents between electrochemical energy stores of an arrangement according to the invention and/or between an electrochemical energy store and an energy drain or an energy source and in the process works towards the prevention or reduction of damage or overloading of the at least one first energy store, accepting damage or overloading of the at least one second energy store, and the protection of the at least one first energy store in this manner. Particularly, but not exclusively in those cases in which the electrochemical energy stores are interconnected with energy sources or energy drains in such a manner that the sum of the energy currents between the electrochemical energy stores and the energy sources and energy drains is predetermined by the behaviour of the energy sources and energy drains, the device according to the invention for controlling the energy currents will control these energy currents such that the energy currents of the energy stores are limited or chosen in such a manner that an exceeding of limit values for damage or overloading of the energy stores to be protected can be prevented.

In order to be able to carry out these control tasks, the device according to the invention for controlling the energy currents preferably has one or a plurality of sensors for measuring parameters of one or a plurality of energy stores, preferably for measuring voltages, particularly terminal voltages of individual or batteries of galvanic cells and/or temperatures, particularly the temperatures of current collectors and/or cooling means which exchange heat with an energy store and/or for measuring electric currents between the energy stores and/or between an energy store and an energy source or energy drain. Preferably, this device additionally has means for influencing the energy currents, preferably switches or transistors, particularly preferably so-called metal oxide field effect transistors (MOSFETs). These means for influencing the energy currents are preferably controlled by control electronics, preferably by an energy management system and/or by a battery management system or by a combination of such systems as a function of the data measured by the sensors.

Preferably, the function of at least one first energy store is based on a first electrochemistry which is different from the second electrochemistry, on which the function of at least one second energy store is based. In this case, one also speaks of a “dual chemistry hybrid” system or else of a hybrid battery or of a hybrid accumulator. Preferably, the various electrochemical reaction systems of the first and of the second energy store are chosen in such a manner that the second energy store can be exposed to higher loads than the first energy store without the second energy store suffering damage in the case of these loads which is comparable to the damage which the first energy store would suffer in the case of these loads. Preferably, the end of charge voltage and/or the end of discharge voltage of the first energy store is different from the end of charge voltage and/or the end of discharge voltage of the second energy store.

Depending on the electrochemical reaction systems used, this is preferably achieved in that galvanic cells at least of a first energy store and/or at least of a second energy store are interconnected in such a manner in parallel, in series or in a combination of series and/or parallel connections, that beneficial end of charge voltages and/or end of discharge voltages of these interconnections result for the respective applications. Preferably, provision is made for these interconnections to be provided by controllable switches, particularly by transistors which are controlled by the device according to the invention for controlling the energy currents, so that this interconnection can be changed flexibly as a function of the circumstances and conditions of the application by the device according to the invention for controlling the energy currents, particularly with the aim that damage or overloading of the at least one first energy store can be prevented or reduced, accepting damage or overloading of a second energy store.

Preferably, the interconnection of the first and second energy stores to one another and/or to at least one energy store or drain by means of the device according to the invention for controlling the energy currents is influenced in such a manner that at least one second energy store is subjected to cycles with larger cycle depth, whereas at least one first energy store is preferably not subjected to such cycles with larger cycle depth or is only subjected thereto to a limited extent, particularly only above or below suitably chosen limit values for the end discharge or end charge voltage.

In the sense of the present invention, the term electrochemistry (or else: cell chemistry) should be understood to mean a chemical reaction system, upon which the function of an electrochemical energy store is based.

Particularly preferably, the function of the first energy store is based on a lithium ion electrochemistry and the function of the second energy store is based on a lead acid electrochemistry.

In the sense of the present invention, the term lithium ion electrochemistry should be understood to mean an electrochemistry in the above-defined sense, which can be considered chemically and physically as the basis of the function of a lithium ion accumulator. Important examples in particular for such an electrochemistry are lithium polymer accumulators, lithium cobalt dioxide accumulators, lithium titanate accumulators, lithium air accumulators, lithium manganese accumulators, lithium iron phosphate accumulators and tin sulphur lithium ion accumulators.

In the sense of the present invention, the term lead acid electrochemistry should be understood to mean an electrochemistry in the above-defined sense, which can be considered chemically and physically as the basis of the function of a lead acid accumulator.

Preferably, at least one of the particularly preferably at least one energy stores in an arrangement according to the invention is a high-energy store, the energy store capacity of which is larger or else substantially larger than the energy store capacity of at least one other energy store in this arrangement according to the invention. Preferably, at least one further, particularly preferably at least one second energy store in such an arrangement according to the invention is a high-performance energy store, the power output capability of which is larger or else substantially larger than the power output capability of at least one other energy store in this arrangement according to the invention.

The invention provides a method for controlling at least one of the energy currents in or out of the first and the second energy store of such an arrangement of electrochemical energy stores in such a manner that damage or overloading of the first energy store can be prevented or reduced, whilst accepting damage or overloading of the second energy store.

Preferably, the method is configured in such a manner that energy exchange processes which are connected to storage cycles with lower depth preferably relate to the first energy store, whereas energy exchange processes which are connected to storage cycles with larger depth preferably relate to the second energy store.

In the sense of the invention, a cycle or storage cycle or charge/discharge cycle should be understood to mean a process made up of two successive steps, in the first step of which energy is removed from or supplied to an electrochemical energy store, and in the following step thereof, energy is supplied to or removed from this electrochemical energy store. In the case of the removal of energy, one speaks of discharging, in the other case of energy supply, one speaks of charging. As the hereby arising energy currents are always connected with electric currents, electrical charges also flow between the involved systems. During the charging of an electrochemical energy store, the voltage initially increases between the electrodes thereof until it asymptomatically approaches a constant voltage value, which is also termed the end of charge voltage, or even falls again. The end of charge voltage at 20° C. in this case is approximately 2.42 V/cell for a lead accu, approximately 1.4 V/cell for an NiCd/NIMH accu, 4.1 V/cell for a lithium ion accu (LiCoO2), 4.2 V/cell for a lithium polymer accu (LiPo) and 4.0 V/cell for a lithium iron phosphate accu (LiFePO4). Preferably, the so-called IU charging method is used here, which is also termed CCCV for constant current constant voltage. In the first stage of the charging, charging is carried out with a constant current limited by the charging device. Compared to the constant voltage charging method, a limiting of the otherwise high initial charging current is effected in this manner. When the chosen end of charging voltage is reached at the accu, a switch is made from current to voltage regulation and further charging is carried out in the second charging phase with constant voltage, in the process the charging current falls with increasing charging state of the accu. In the case of lead and Li ion accus, the falling below a chosen minimum charging current can be applied as a criterion for the ending of the charging. The depth of the charging therefore depends on the chosen end of charge voltage.

The end of charge voltage is the voltage at which the discharging of a battery or an accumulator (accu) is ended. Usually, the end of discharge voltage is defined as the voltage below which no further energy usable for the respective application can be removed from an electrochemical energy store. The lower the end of discharge voltage is, the more energy the battery or the accumulator can supply. If however the cut-off voltage of the consumer is above the end of discharge voltage of the accu, then the accu is not completely discharged at all and the residual capacity of the accu is unused and cannot be utilised by the consumer.

In the case of accumulators and accu packs, end of discharge voltage also designates the voltage, up to which they may be discharged without risking damage. If the end of discharge voltage is fallen below (so-called deep discharge), in certain systems (for example in the case of a lead accumulator, a nickel cadmium accu or a nickel metal hydride accu) an impairment of the rechargeability may arise. The depth of discharge (DoD) is specified in percent. For most accus, the service life increases with reduced depth of charge and correspondingly increased charging frequency. Preferably, Li ion accus are not discharged deeper than 30%.

If the energy supplied during charging corresponds to the energy removed during discharging, one speaks of a cycle or storage cycle or charge/discharge cycle. The value of this energy is a measure for the so-called depth of cycle. The larger is the depth of cycle, generally the larger is the loading of the energy store connected with the cycle, particularly above a threshold for the depth of cycle, which is dependent on the electrochemistry and the structure of the energy store. Correspondingly, the likelihood for damage and/or ageing of the energy store generally increases with the depth of cycle. If one wants to prevent or reduce damage or the risk of damage of an energy store, one accordingly chooses the depth of cycle to rather not be too large, preferably smaller or substantially smaller than the maximum possible depth of cycle.

If situations arise in connection with the use of an arrangement of electrochemical energy stores according to the invention, in which the nature of the use requires a number of cycles with different, for example statistically distributed depths of cycle, then the invention preferably provides to control the energy currents in such a manner that energy stores to be protected are affected by the possibly less frequent cycles with larger depth of cycle less than other energy stores of the arrangement or even are not affected. Preferably, the energy current between an energy store to be protected (from damage or overloading) and an energy source or energy drain before or at the reaching of the end of charge voltage or the end of discharge voltage is reduced or even interrupted. In order to be able to nonetheless be able to fulfil the chosen application if possible, the energy current between at least one other energy store and an energy source or energy drain is increased if required or adapted in accordance with the chosen application in this situation.

Preferably, an arrangement according to the invention made up of batteries or modules is built and preferably has a lead battery and a lithium ion battery, wherein the lead battery if necessary preferably accommodates currents, that is to say electric currents and/or energy currents, from the lithium ions and keeps these currents in a safe operating window. This preferably takes place in such a manner that in each case only a statistically likely fault of modules is or can be captured, for example per 500 Ah of the lithium ion battery, 100 Ah of the lead battery or per 500 Ah of the lithium ion battery, 350 Ah of the lead battery, wherein the ratio can also be reversed as long as it is ensured that for example an overload current of the lithium ion battery is conducted away and to the lead battery. Preferably, this takes place by means of switches, MOSFETs and an intelligent battery management system.

A lead battery can process a possible overloading relatively well compared to a lithium ion battery. It can therefore be used as sacrifice battery, if as a consequence of this, damage or ageing of the lithium ion battery can be avoided or prevented. With this strategy, a considerable lengthening of the service life of the lithium ion battery is possible, specifically also if the same is equipped with a so-called redox shuttle, because the same have a limited operating or service life or because the operating characteristics ultimately also reduce the energy density.

Preferably, by means of this strategy, the diversion of currents between the energy stores, preferably away from the lithium ion battery and to the lead battery, the end of charge voltage of the lithium ion battery is particularly also reduced, which in particular in the case of applications in connection with photovoltaic energy sources (so-called solar cycles), increases the service life of the lithium ion battery considerably.

In test rows, particularly within a project for hybridising lithium batteries in stationary applications with fluctuating operation, a lithium ion cell could be identified as a result of the cell selection, which has a correspondingly high cycle number for the application considers, with the aim of integrating lithium ion batteries into the field of application of stationary island systems. In the case of a low depth of cycle (20% DOD), a capacity of virtually 100% was still available after 7000 cycles. Also, in the case of cycling of 50% DOD, good values were still achieved. On the basis of the results of these investigations and of simulations, an energy management algorithm was developed, which distributes the “cycle load” or a large part of the cycles onto the lithium ion storage system and the still remaining few, but deeper cycles onto the lead storage system. In this manner, due to the hybridisation, the advantages of the lithium battery and the lead battery can be combined with one another, avoiding the disadvantages thereof.

In the following, the invention is explained in more detail on the basis of preferred exemplary embodiments and with the aid of the figures.

In the figures

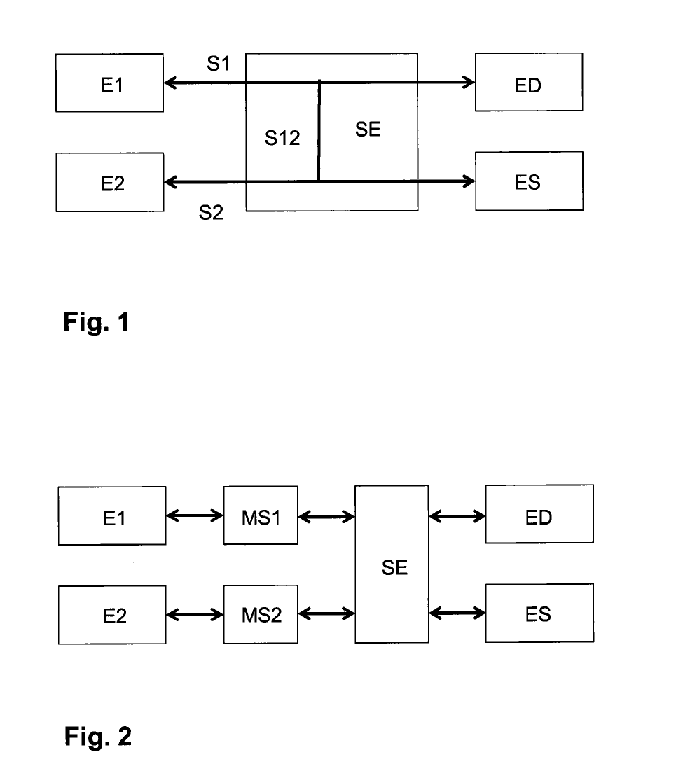

FIG. 1 shows an arrangement according to the invention according to a first exemplary embodiment of the present invention;

FIG. 2 shows an arrangement according to the invention according to a second exemplary embodiment of the present invention;

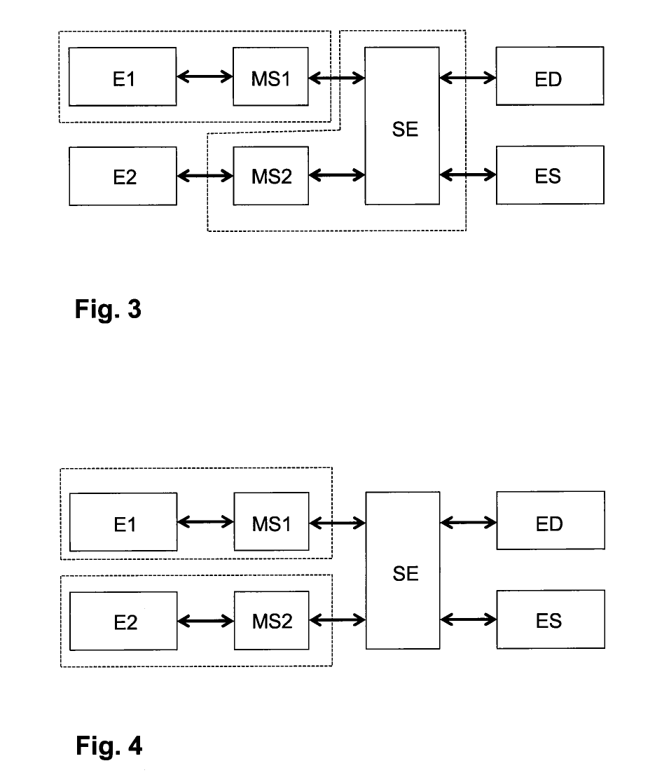

FIG. 3 shows an arrangement according to the invention according to a third exemplary embodiment of the present invention; and

FIG. 4 shows an arrangement according to the invention according to a fourth exemplary embodiment of the present invention.

The exemplary embodiment of the invention shown in FIG. 1 provides an energy source ES and an energy drain ED which is interconnected via a device SE for controlling the energy currents S1, S2 and S12 to a first electrochemical energy store E1 and to a second electrochemical energy store E2 in such a manner that an energy current output by the energy source ES can be accommodated by the energy stores E1 and/or E2, as a result of which the same are charged. As the charging of the energy stores takes place by means of electrical energy transport, electric currents are connected to the energy currents, the size of which depends in the case of given energy currents on the prevailing electric voltage. The energy source can be a public supply network, a generator, a photovoltaic installation or a different energy source. The energy drain can be a consumer, a public supply network or another type of energy drain.

The inner structure of the device SE for controlling the energy currents and the relationship of the energy currents S1, S2 and S12 are only illustrated symbolically in FIG. 1, as the actual relationships can be very complicated, depending on the actual configuration of the embodiment. All preferred configurations have it in common that the device SE controls the energy currents, particularly the electric currents, in such a manner that an energy current between the energy source and/or the energy drain given by the in each case prevailing situation of the application considered can be combined with the currents S1, S2, S12 and that in addition these currents, particularly the current S1 is controlled in such a manner that damage of the energy store E1 is if possible reduced, if necessary accepting a preferably temporary overloading or even damage of the energy store E2.

In order to explain the invention on the basis of an example, it may be assumed that the energy drain ED is the electric drive of a vehicle, particularly of an electric car. The energy source ES may be an internal combustion engine, which is brought into operation from time to time in order to charge the energy stores E1 and E2. The energy store E1 may be an Li ion accumulator structured as a plurality Li ion cells with a high storage capacity compared to the capacity of the energy store E2. The energy store E2 may be a lead battery.

If the drive ED then demands an energy current in a situation in which the energy store E1 is already strongly discharged, which would lead to an overloading (deep discharge) of the energy store E1 if this energy current were provided exclusively by E1, then the device SE controls the energy currents S1, and S2, so that S1 is limited to values which prevent or reduce an overloading of E1. In this case, a deep discharge of E2 is accepted. A damage of E2 possibly connected therewith leads to lower costs than a damage of E1 and can therefore be accepted.

If, in another situation in which the energy store E1 is already virtually fully charged, the energy supply of the energy source ES is temporarily so high that a storage of these energy currents in E1 would lead to an overloading (overcharging) of E1 and if this energy should not remain unused however, then the device SE controls the energy currents 51 and S2 in such a manner that S1 is limited to values which prevent or reduce an overloading of E1. In this case, an overloading of E2 is accepted. A damage of E2 possibly connected therewith leads to lower costs than a damage of E1 and can therefore be accepted.

Situations of this type occur in particular in connection with charge and discharge cycles, the depth of cycle of which, preferably characterised by the end of charge voltages and/or end of discharge voltages of the energy stores involved or the cells constituting the same, is statistically distributed. Depending on the application context, different distributions of depths of cycle are considered. In these cases, the device SE will control the energy currents in such a manner that cycles with a small depth of cycle are preferably overcome by energy currents from and to the energy store E1, whereas cycles with a large depth of cycle are preferably overcome by energy currents from and to the energy store E1. To this end, limit values are preferably determined for each energy store, which characterise the same, preferably the end of charge and end of discharge voltages, the operating temperatures, etc., which should or must not be exceeded or fallen below. Particularly preferably, target functions are determined, which constitute a measure for the loading, overloading and/or damage, particularly the ageing of one or a plurality of energy stores or for the operating danger connected with these energy stores. These target functions are preferably optimised by the device SE, in order to achieve the goal of preventing or reducing overloading and/or damage in such a manner.

Modern electrochemical energy stores often have a battery management system (succinctly: BMS), that is to say via electronic circuits which are used for monitoring and regulating an accumulator system, i.e. an interconnection of a plurality of accu cells to form a battery. The BMS should in this case detect, monitor and correct unavoidable production-associated scatterings of various parameters of the accu cells, for example the capacity and the leak currents. BMSs are to be found in different interconnections of accumulator cells, for example in traction batteries of electric cars, in emergency power systems (so-called USVs) or else in notebooks. A simple form of a BMS for a few cells is a charge regulator. Advanced BMSs often have complex controls which monitor accumulator cells and provide information about the state thereof. Inter alia, the aim is the monitoring of the charging state which can only be determined with difficulty in the case of many accumulator types. Particularly important is a battery management system in connection with accumulators based on lithium, in which the individual cells also have to be monitored.

Lead accumulators with a cell voltage of 2 V/cell have a single charging characteristic and are relatively robust with regards to overcharging. The energy which cannot be stored is converted into heat. In conventional lead batteries with 3, 6, 12 cells (6, 12, 24 V), a BMS is therefore dispensed with for the most part. In the case of use as a traction battery, the absence of a BMS can be felt through the cyclic charging/discharging in the drifting apart of the cells and blocks. This leads to a possible deep discharge and as a consequence to a possible failure of the defective cells.

Accumulators based on lithium have a single, proportional charging characteristic, similar to the charging characteristic of lead accumulators. However, unlike lead accumulators, they react in a very sensitive manner to an over- or undervoltage. Particularly in a series connection of a plurality of cells, a monitoring of these cells is very important in order to effectively prevent a premature failure or an overheating in the case of overcharging. In the case of a use of the BMS in lithium ion accus, in addition to the temperature control, the diagnosis and the charge state determination, principally charge and discharge control and balancing, that is to say the compensation of uneven charging states of the individual cells of a battery, therefore result.

In the FIGS. 2, 3 and 4, exemplary embodiments of the invention are illustrated schematically, in which battery management systems MS1 and MS2 take on the battery management of the energy store E1 or E2. These battery management systems MS1 and MS2 can be realised as discrete constituents of an arrangement according to the invention in accordance with FIG. 2 or as integrated constituents of the energy store or the device SE for controlling the energy currents. The person skilled in the art can easily discover further embodiments not illustrated in FIGS. 1 to 4 on the basis of the present description. An integration of individual or all BMSs into the device SE for controlling the energy currents is connected with the advantage that communication channels for transmitting signals between the BMSs and the device SE for controlling the energy currents for realising a tailored control in a simple manner can be realised in particular without additional signal transmission devices between the BMSs MS1 and MS2 and the device SE for controlling the energy currents.

### REFERENCE LIST

E1 First electrochemical energy store
E2 Second electrochemical energy store
SE Device for controlling energy currents
ES Energy source
ED Energy drain, consumer
MS1 First battery management system
MS2 Second battery management system

1. An arrangement of electrochemical energy stores, comprising:
at least one first rechargeable electrochemical energy store and at least one second rechargeable electrochemical energy store, wherein the first and the second energy stores are connected to one another to exchange energy with one another and with at least one of an external energy source or an external energy drain via energy currents;
a device to control at least one of the energy currents in or out of the first and the second energy store to prevent or reduce damage or overloading of the at least one first energy store, whilst accepting damage or overloading of the at least one second energy store.

2. The arrangement according to claim 1, wherein a function of the first energy store is based on a first electrochemistry which is different from the second electrochemistry, on which a function of the second energy store is based.

3. The arrangement according to claim 2, wherein the function of the first energy store is based on a lithium ion electrochemistry and in that the function of the second energy store is based on a lead acid electrochemistry.

4. A method for controlling at least one of the energy currents in or out of the first and the second energy store of an arrangement of electrochemical energy stores according to claim 1 in such a manner that damage or overloading of the first energy store is prevented or reduced, whilst accepting damage or overloading of the second energy store.

5. The method according to claim 4, wherein energy exchange processes which are connected to storage cycles with lower depth relate to the first energy store, and energy exchange processes which are connected to storage cycles with larger depth relate to the second energy store.

6. The method according to claim 5, wherein storage cycles with a depth of discharge down to a residual charge below 20% of full charge relate to the first energy store, and energy exchange processes which are connected to storage cycles with larger depth relate to the second energy store.

7. The method according to claim 5, wherein storage cycles with a depth of discharge down to a residual charge below 30% of full charge relate to the first energy store, and energy exchange processes which are connected to storage cycles with larger depth relate to the second energy store.

8. The method according to claim 5, wherein storage cycles with a depth of discharge down to a residual charge below 40% of full charge relate to the first energy store, and energy exchange processes which are connected to storage cycles with larger depth relate to the second energy store.

9. The method according to claim 5, wherein storage cycles with a depth of discharge down to a residual charge below 50% of full charge relate to the first energy store, and energy exchange processes which are connected to storage cycles with larger depth relate to the second energy store.

10. A device to carry out a method according to claim 4.
